(19) United States
(12) Patent Application Publication
(10) Pub. No.: US 2017/0161662 A1
(43) Pub. Date: Jun. 8, 2017

(54) MANAGING USE OF LICENSE-BASED SOFTWARE APPLICATIONS

(71) Applicant: GM Global Technology Operations LLC, Detroit, MI (US)

(72) Inventors: Chijou WANG, Farmington Hills, MI (US); Manoj K. MONINGI, Troy, MI (US); Yangbing ZENG, Troy, MI (US)

(21) Appl. No.: 14/956,779

(22) Filed: Dec. 2, 2015

(51) Int. Cl. G06Q 10/06; G06F 21/10; G06Q 30/00

(52) U.S. Cl. CPC G06Q 10/06315; G06Q 10/0633; G06Q 30/0185; G06F 21/105

(57) ABSTRACT

A system and method of managing software license usage includes: receiving a simulation model that will be processed using two or more license-based software applications; identifying a first license key that will be used to process at least a portion of the simulation model; identifying a second license key that will be used to process at least a portion of the simulation model; and processing the simulation model using the first license key and the second license key, wherein the first license key and the second license key are not used simultaneously and the unused key remains in a shared pool of available license keys.

### TECHNICAL FIELD

The present invention relates to managing software license usage and, more particularly, to managing the selection of software keys for processing a simulation model.

### BACKGROUND

Software applications simulating the behavior of a part or system of parts analyze simulation models that include proposed specifications for the parts/system developed by engineers or technical designers. Owners of these software applications control their use based on a license agreement between owner and user. Often, the user pays the owner a license fee in return for accessing the software application and applying its functionality to the simulation models. Given the license fee cost, purchasers of license-based software applications may attempt to minimize the number of purchased software applications or license keys and maximize their the use of the license-based software application.

Some simulation models include data that is processed using more than one license-based software application. As the simulation model is processed, two or more license-based software applications are engaged such that the license keys or permissions needed to operate the software applications are unable to be used by others. However, even though two or more license keys are engaged by the simulation model, only one license-based software application may be in use at any one time. Given this, one or more license-based software applications may be left idle, yet unable to be used by others. It would be helpful to more efficiently manage license-based software applications to make them available more often.

### SUMMARY

According to an embodiment of the invention, there is provided a method of managing software license usage. The method includes receiving a simulation model that will be processed using two or more license-based software applications; identifying a first license key that will be used to process at least a portion of the simulation model; identifying a second license key that will be used to process at least a portion of the simulation model; and processing the simulation model using the first license key and the second license key, wherein the first license key and the second license key are not used simultaneously and the unused key remains in a shared pool of available license keys.

According to another embodiment of the invention, there is provided a method of managing software license usage. The method includes receiving a simulation model that will be processed by two or more license-based software applications; determining that the simulation model will be processed using different license keys for each of the two or more license-based software applications, wherein the license keys are selected from a shared pool of available license keys; identifying a first portion of the simulation model that will be processed using a first one of the license-based software applications operated using a first one of the license keys; activating the first license-based software application operated using the first license key; processing the first portion of the simulation model on one or more computers using the first license-based software application operated using the first license key; determining that a second portion of the simulation model will be processed using a second one of the license-based software applications operated using a second one of the license keys; stopping processing of the first portion of the simulation model using the first license-based software application operated using the first license key; returning the first license key to the shared pool of available license keys; and processing the second portion of the simulation model on one or more computers using the second license-based software application operated using the second license key, whereby only one of the license keys are used at a time while processing the simulation model.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a computer system that is capable of utilizing the method disclosed herein; and

FIG. 2 is a flow chart depicting an embodiment of a method of managing software license usage.

### DETAILED DESCRIPTION OF THE ILLUSTRATED EMBODIMENT(S)

The system and method described below manages the use of license-based software applications. Engineers and technical designers create simulation models that represent hypothetical parts or systems of parts the license-based software applications analyze to determine how the parts/systems will behave if actually built. Analysis of the simulation models involves accessing more than one license-based software application before analysis is complete. To do so, the simulation models—in the past—have engaged or otherwise tied up a license key for each license-based software application used to process the models throughout the analysis, regardless of whether the software applications are actively used during the analysis time or not.

In the present system and method, the simulation models can be analyzed using only one license key at a time even though the simulation models will call on a plurality of license-based software applications to complete analysis. A local or remote computer containing license-based software applications can receive a simulation model that will be processed using two or more of the software applications. After receiving the simulation model, the remote computer can divide the simulation model into a plurality of portions and identify the license-based software application used to process each portion. The computer can identify a first license key that will be used to process a first portion of the simulation model and a second license key that will be used to process a second portion of the simulation model. Depending on which portion of the simulation model currently being processed, the remote computer can engage or use only the license key that is presently needed. For example, if the first portion is processed first, the remote computer can engage the first license key while leaving the second license key available for use by others in a shared pool of available licenses. When processing of the first portion is complete but before processing of the second portion begins, the remote computer can release the first license key returning it to the shared pool and query the shared pool to determine the availability of the second license key. If available, the remote computer obtains the second license key and begins processing the second portion; otherwise, if the second license key is not available, processing can wait until the second license key is free.

The selective engagement of license keys to process simulation models using a plurality of license-based software applications can make license keys more frequently available to other users when the software applications associated with those license keys are not actively used. The greater availability of the license keys may reduce the number of pooled keys and may increase the usage of the license-based software application, which can thereby increase the utility of the application per license fee paid. While the license-based software application management system/method has been described herein with respect to simulation models created by engineers, it should be appreciated that the system and method can also be used in non-engineering settings in which multiple license-based software applications are engaged or tied up when only one application is used at a time. And even though the system and method is described with respect to two license keys and two portions of a simulation model, it should be apparent that the system and method can be applied to simulation models processed using more than two license keys, more than two portions within the simulation model, or both.

### Computing System—

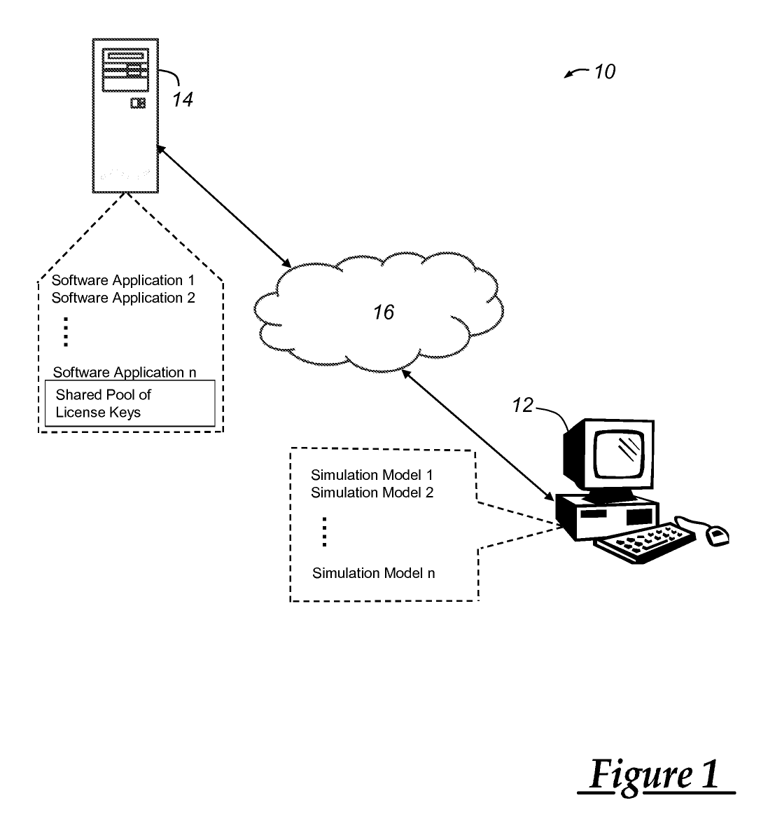

With reference to FIG. 1, there is shown a computing system 10 that can be used to implement the method described below. The system 10 generally includes a personal computer (PC) 12 that is linked to a central computer network 14 via a land network 16. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such computing system 10; however, other systems not shown here could employ the disclosed method as well.

Personal computer (PC) 12 can be a computing device operated by an engineer or technical designer that includes hardware in the form of one or more microprocessors, memory devices, peripherals, and modems. A typical PC 12 can receive input from peripherals such as a keyboard and a mouse and output information via other peripherals, such as a monitor. In this arrangement, it is common for the PC 12 to be remain stationary on a desktop or other similar location. However, it is also possible to implement the PC 12 as a portable device having many if not all of the elements discussed above, such as a laptop or handheld computer (not shown). The microprocessors of the PC 12 can include a central processing unit (CPU) that executes software or software instructions in form of computer-readable code. The software can be stored in the memory device, which can be any type of non-volatile memory as is known in the art. Communications between the CPU and other hardware elements can be carried out over a bus, as can be implemented using a printed circuit board (PCB). Even though only one PC is shown, the computing system 10 can incorporate many PCs that access the central computer network 14 via the land network 16. Alternatively, a plurality of PCs can access a central computer network 14 as part of a private local area network (LAN) without using the land network 16 for communications.

One or more simulation models (shown in FIG. 1 as simulation models 1-n) can be created on the PC 12 or uploaded from a separate memory device communicatively linked to the PC 12, such as a USB flash drive. Simulation models can include data that reflects assumptions or proposed design parameters of a physical part or system of parts. The data included in the simulation models can be analyzed by license-based software applications (shown in FIG. 1 as software applications 1-n) to predict the performance of the parts or system if actually built. Proposed design parameters can include the size of parts, the material chosen to construct the parts, the location of the parts with respect to other parts or the environment in which they will be used, and other similar variables. These simulation models are commonly used to carry out finite element analysis (FEA) or computational fluid dynamics (CFD) as is known to those skilled in the art. The simulation model can exist as a standalone model file often using a .sim file extension.

License-based software applications are used to process the simulation models and can be enabled by a shared pool of available licenses represented by license keys stored at the central computer network 14. In some implementations, these software applications can be stored locally at the PC 12. When simulation models are processed by software applications stored at the PC 12, it can query a shared pool of license keys at the central computer 14 for available software applications to determine if a particular software license is available to enable a particular license-based software application. Or in another implementation the software applications can reside on the central computer network 14 and the simulation model can be sent to the central computer network 14 for processing. The central computer network 14 can locally query the shared pool of license keys to determine if a particular software license is available to enable a particular license-based software application. FIG. 1 depicts an arrangement in which the software applications may be stored at the central computer network 14 along with a shared pool of license keys. A number of license-based software applications currently exist and are known to those skilled in the art. For example, CD-Adapco currently offers its STAR CCM+ software application that can analyze simulation models to solve problems involving flow, heat transfer, and stress. These license-based software applications may cost a significant amount per month for each software application. Thus, maximizing the use of the license-based software application can help maximize work output of each license-based software application relative to its cost. This can reduce the number of licenses needed.

License keys for the software applications can be stored in the shared pool of available licenses that is searchable by the PC 12 or the central computer network 14. When a particular license-based software application is needed, the PC 12 or the central computer network 14 can query the shared pool to determine if the license key associated with the license-based software application is engaged such that the software application is currently in use. In one implementation, the PC 12 can use its CPU to access license keys from the central computer network 14 via the land network 16. The land network 16 may be a conventional land-based telecommunications network that is connected to one or more landline telephones. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof.

The central computer network 14 can be one of a number of computers that are accessible via a private or public network such as the Internet and maintain license-based software applications. The central computer network 14 can act as a repository for the license-based software applications, the shared pool of license keys, or both. Rather than maintaining the software applications locally at the PC 12, it may transmit its simulation models to the central computer network 14 for processing or access the functionality of the software applications stored at the network.

### Method—

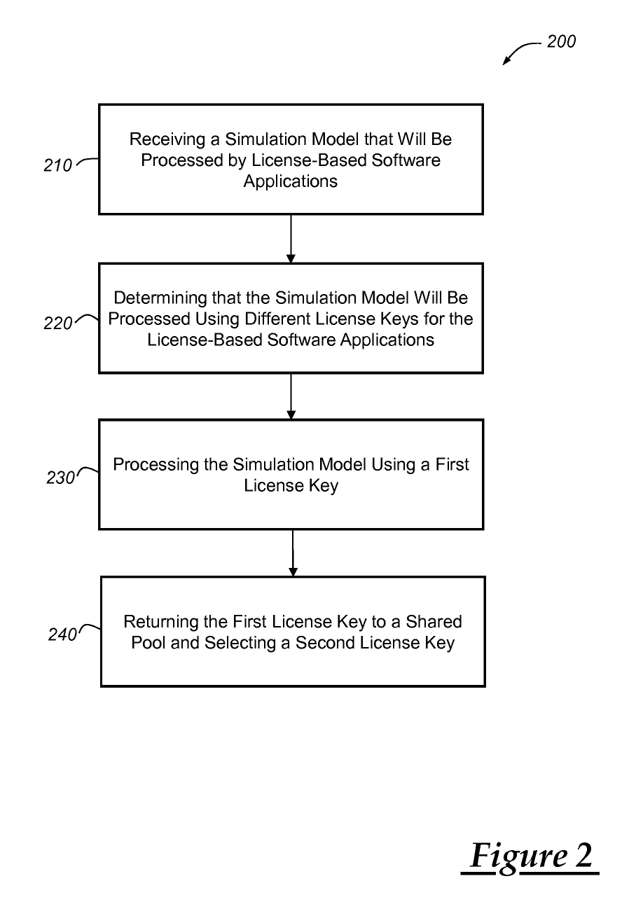

Turning now to FIG. 2, there is shown an embodiment of a method 200 of managing software license usage. The method 200 begins at step 210 by receiving a simulation model that will be processed by two or more license-based software applications. The user, after creating a simulation model to be analyzed by a plurality of license-based software applications, can initiate analysis of the model. Initiation can begin at the PC 12 at the direction of the user. Afterwards, the simulation model can be analyzed using license-based software applications stored at the PC 12 or the simulation model can be transmitted to the central computer network 14 via the land network 16. The simulation model can then be processed using the plurality of license-based software applications at the central computer network 14. The method 200 proceeds to step 220.

At step 220, it is determined that the simulation model will be processed using different license keys for each of the two or more license-based software applications selected from a pool of available license keys. The simulation model can be divided into a plurality of portions. These portions can be defined or delineated by the particular license-based software application that is used to process the portions. For example, one portion of the simulation model can involve processing an aspect of the model to determine transient behavior using a first license-based software application while a second, different portion of the simulation model involves a second license-based software application for determining steady state behavior.

A first license key that will be used to process the first portion of the simulation model can be identified as well as a second license key that will be used to process a second portion of the simulation model. The first and second license-based software applications can be activated or made operational by associated first and second license keys, respectively. After reading the content of the simulation model, the PC 12 or the central computer network 14 can identify each of the license-based software applications that will be called on during the analysis of the model. The availability of license keys for each of these applications can then be determined by querying the shared pool of available license keys. The shared pool can distribute license keys among a plurality of users or requesters and regulate access to those keys depending on whether the license-based software application controlled by the key is already in use. Once it is determined that the first license key is needed, the PC 12 or central computer network 14 can query the shared pool to request use of the first license key. If the first license key is not available, the shared pool can deny the request and the PC 12/central computer system 14 can repeat its request later. If the first license key is available, the shared pool records the use of the first license key and transmits the key to the entity carrying out processing using license-based software applications. Step 220, as well as the other steps of method 200, can be executed using scripts written in Java. However, it should be understood that these steps could alternatively be implemented using different computer languages. The method 200 proceeds to step 230.

At step 230, the first portion of the simulation model is processed using the first license key. The first license-based software application can be activated and operated using the first license key. Once the first license key is received from the shared pool, the first license-based software application can be activated and used to process the first portion of the simulation model. The first license key and the second license key are not used simultaneously and unused keys can remain in the shared pool of available license keys. The method 200 proceeds to step 240.

At step 240, the first license key can be returned to the shared pool of license keys and a second license key activating a second license-based software application can be selected. Once processing of the first portion of the simulation model using the license-based software application is complete, the first key can be returned to the shared pool. It is possible that this involves the PC 12 or central computer system 14 informing the shared pool that it is at least temporarily finished using the first license-based software application. Even though analysis of the simulation model is not complete, the return of the first license key to the shared pool makes the first license-based software application available for other users. The shared pool can then be queried to determine if the second license key is available. If the second license key is available, the PC 12 or central computer network 14 can receive the second license key from the shared pool and process the second portion in a similar way that the first portion is processed. And if the second license key is not available, the PC 12 or central computer network 14 can wait and reattempt querying the shared pool to see if the second license key is available. Once all of the portions of the simulation model have been processed, the license keys associated with the license-based software applications that carried out the processing can be returned to the shared pool. The method 200 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of managing software license usage, comprising the steps of:
(a) receiving a simulation model that will be processed using two or more license-based software applications;
(b) identifying a first license key that will be used to process at least a portion of the simulation model;
(c) identifying a second license key that will be used to process at least a portion of the simulation model; and
(d) processing the simulation model using the first license key and the second license key, wherein the first license key and the second license key are not used simultaneously and the unused key remains in a shared pool of available license keys.

2. The method of claim 1, wherein the simulation model is received and processed at a personal computer (PC).

3. The method of claim 1, wherein the simulation model is received and processed at a central computer network.

4. The method of claim 1, wherein the simulation model is processed to determine transient behavior or steady state behavior.

5. The method of claim 1, wherein steps (a)-(e) are carried out using a Java-based script.

6. The method of claim 1, wherein the shared pool of available license keys is stored at a central computer network.

7. The method of claim 5, further comprising the step of accessing the shared pool of available license keys from a personal computer (PC).

8. A method of managing software license usage, comprising the steps of:
(a) receiving a simulation model that will be processed by two or more license-based software applications;
(b) determining that the simulation model will be processed using different license keys for each of the two or more license-based software applications, wherein the license keys are selected from a shared pool of available license keys;
(c) identifying a first portion of the simulation model that will be processed using a first one of the license-based software applications operated using a first one of the license keys;
(d) activating the first license-based software application operated using the first license key;
(e) processing the first portion of the simulation model on one or more computers using the first license-based software application operated using the first license key;
(f) determining that a second portion of the simulation model will be processed using a second one of the license-based software applications operated using a second one of the license keys;
(g) stopping processing of the first portion of the simulation model using the first license-based software application operated using the first license key;
(h) returning the first license key to the shared pool of available license keys; and
(i) after step (g), processing the second portion of the simulation model on one or more computers using the second license-based software application operated using the second license key, whereby only one of the license keys are used at a time while processing the simulation model.

9. The method of claim 8, wherein the simulation model is received and processed at a personal computer (PC).

10. The method of claim 8, wherein the simulation model is received and processed at a central computer network.

11. The method of claim 8, wherein the simulation model is processed to determine transient behavior or steady state behavior.

12. The method of claim 8, wherein steps (a)-(i) are carried out using a Java-based script.

13. The method of claim 8, wherein the shared pool of available license keys is stored at a central computer network.

14. The method of claim 13, further comprising the step of accessing the shared pool of available license keys from a personal computer (PC).
